(19) United States
(12) Patent Application Publication
(10) Pub. No.: US 2010/0077280 A1
(43) Pub. Date: Mar. 25, 2010

(54) SEMICONDUCTOR RECORDING DEVICE

(76) Inventor: Takeshi OOTSUKA, Hyogo (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/563,264

(22) Filed: Sep. 21, 2009

(30) Foreign Application Priority Data
Sep. 22, 2008 (JP) 2008-242593

(51) Int. Cl. G06F 11/10

(52) U.S. Cl. 714/758; 714/E11.04

(57) ABSTRACT

The present invention intends to provide a semiconductor recording device that is able to continuously record data and has high reliability even in a case where writing errors frequently occur. When data to be written is recorded as an error correction code (ECC) in a plurality of physical blocks constituting a nonvolatile memory and a writing error occurred, a time interval between the writing error that occurred immediately before and the present writing error is detected. Then, when the time interval is within a first reference time, an error position management unit registers a writing error occurrence block number and block numbers grouped with the writing error occurrence block in the ECC. Then, the writing error registered in the error position management unit is read at a predetermined timing, and the error is corrected on the basis of the ECC and the corrected data is rewritten. In this manner, since overflow of a buffer memory of the host apparatus can be avoided, real-time recording can be realized even in the case where the writing errors frequently occurred.

### BACKGROUND OF THE INVENTION

1. Field of the Invention

The present invention relates to a semiconductor recording device such as a memory card, and especially relates to a semiconductor recording device for restoring a writing error generated in an internal nonvolatile memory.

2. Discussion of the Related Art

A semiconductor recording device such as an SD (Secure Digital) card (Registered trademark) that is a card-type recording medium incorporating a flash memory is considerably-small, considerably-thin, and easily-handled, and accordingly has been widely used for recording data such as image data in a digital camera, a mobile phone, or the like.

The flash memory incorporated in the semiconductor recording device is composed of many physical blocks each having a constant size, and is a memory able to erase data in units of the physical block. To meet a recent demand for highly-enlarged capacity, a multi-level flash memory able to store data of more than 2 bits in one cell is commercialized as the flash memory.

FIG. 1 shows one example of relationship between the number of electrons accumulated in a floating gate of the multi-level flash memory and a threshold voltage (Vth). As shown in FIG. 1, a four-level flash memory controls an accumulation state of electrons of the floating gate in four states in accordance with the threshold voltage (Vth). An electric potential is the lowest in an erased state, and the state is indicated by (1, 1). Then, the threshold voltage discretely rises as the electrons are accumulated, and the states are indicated by (1, 0), (0, 0), and (0, 1). Since the electric potential rises in proportion to the number of accumulated electrons, the 2-bit data can be recorded in one memory cell by controlling the electric potential to fall within a predetermined threshold of the electric potential.

FIG. 2 shows a schematic view of one physical block of the four-level flash memory. The physical block shown in FIG. 2 is composed of 2K (K is a natural number) pages. And, a writing process is carried out in ascending order from a page number 0. Here, it is assumed that a page of page number m (0≦m≦K) and a page of page number (K+m) are in a relationship of sharing one memory cell (hereinafter referred to a cell sharing relationship). In the pages being in the cell sharing relationship, the firstly-written page is called a first page and the subsequently written page is called a second page. Specifically, the writing to the page number m (the writing to the first page) and the writing to the page number (K+m) (the writing to the second page) are carried out by charging electrons into an identical cell. To explain referring to FIG. 1, the electric potential is controlled so as to rise up to a half of the maximum level in the writing to the first page, and the electric potential is controlled so as to rise from the half level to the maximum level in the writing to the next second page.

FIG. 3 shows a shift of a state of the flash memory cell. As shown in FIG. 3, the state of one memory cell of the physical block of the flash memory shifts as follows:

(a) after erasing data, the state of the memory cell is (1, 1),

(b) after the writing to the first page, the state of the memory cell is (1, 1) or (1, 0), and

(c) after the writing to the second page, the state of the memory cell is (1, 1), (1, 0), (0, 0), or (0, 1). As explained above, in the multi-level flash memory, the multi-value recording for controlling an accumulation amount of electrons in the flash memory is carried out by providing a plurality of threshold values to the Vth, and the large capacity is realized.

The shift of states of the above-mentioned (b) and (c) will be explained. In (b), the state after the writing of 1 to the first page of a memory cell is (1, 1), and the state after the writing of 0 is (1, 0). Additionally, in (c), the shift is limited depending on the state in (b). Specifically, in (b), the shift from the state of (1, 1) is to keep the state of (1, 1) when 1 is written or to change the state to (0, 1) when 0 is written. Meanwhile, in (b), the shift from the state of (1, 0) is to keep the state of (1, 0) when 1 is written or to change the state to (0, 0) when 0 is written.

However, in a process of the shift from (b) to (c), a problem that a writing error propagates to the already-written first page occurs. Specifically, in injecting electrons to shift the state of a memory cell from (1, 1) to (0, 1) in (b), the electric potential sometimes stops rising halfway before rising to the Vth corresponding to (0, 1). For example, if the rising stops at (1, 0), the already-written first page shifts from 1 to 0. In this case, the error propagates not only to the second page but also to the first page.

In FIG. 2, in the case of the writing to the first page, namely, the writing to page 0 to page (K−1), the writing error is an error where the Vth does not rise from the state of (1, 1) to the state of (1, 0). In addition, the state of the Vth is (1, 1), (1, 0), (0, 0), or (0, 1) after the writing to the second page, namely, the writing to page K to page (2K−1). The writing error of this case includes the following two types.

(Error 1): the Vth (1, 0) does not rise to (0, 0).

(Error 2): the Vth (1, 1) does not rise to (0, 1).

In the case of error 1, since the Vth (1, 0) and the Vth (0, 0) lay side-by-side, an error does not propagate to the first page. However, in the case of error 2, there are two states of the Vth between the Vth (1, 1) and the Vth (0, 1). Particularly, in a case where the Vth (1, 0) is a value after the writing to the first page and the Vth has risen only up to (1, 0), not only the second page results in the writing error, but also data in the first page is lost. For example, when a writing error occurs in the writing to the page K, there is a possibility to lost the data in already-written page 0.

To solve the problem, in Japanese Unexamined Patent Publication No. 2006-318366, a buffer memory is installed in a memory controller for controlling the flash memory, and the controller controls so as to store the data of the first page in the buffer memory until the writing to the second page and to rewrite the data of the first page in the buffer memory to the flash memory when a writing error occurs in the writing to the second page.

However, the conventional method has to retain the data of the first page in the buffer memory until the writing to the second page ends and to carry out the writing again returning to the writing to the first page when a writing error has occurred in the writing to the second page.

Additionally, in a case where information of cell-sharing pages is not disclosed, when an error occurs in the writing to a certain page, data have to be written again in all written pages including the page in the physical block at the time because the first page and the second page are not distinguished.

A size of the physical block of the multi-level flash memory increases in accordance with the refinement of the process, and time required for the rewriting in units of physical blocks becomes long in proportion to the physical block size. Accordingly, in a case of recording image signals with a high bit rate in real time to a semiconductor recording device employing the flash memory, a buffer memory of a host apparatus overflows. That is, the conventional method can restore the error propagation occurring because of the writing error in the multi-level flash memory, but produces a new problem; data to be rewritten in accordance with the restoration increases and accordingly a processing time for the rewriting increases.

### SUMMARY OF THE INVENTION

The present invention is to solve the above-mentioned problems, and intends to provide a semiconductor recording device with high reliability that is able to write data continuously even when a many writing errors occur.

A semiconductor recording device that incorporates a nonvolatile memory composed of a plurality of physical blocks, the physical block being composed of a plurality of pages, and configures the predetermined number of said physical blocks as one group, comprises: an ECC generation unit for adding an ECC parity to data inputted in data writing and generating an error correction code; a data distribution unit for distributing component units of the error correction code generated by said ECC generation unit to each physical block of one group; a data writing unit for writing the data distributed by said data distribution unit into each physical block of the one group of the nonvolatile memory; a writing error detection unit for detecting a writing error in the data writing to the nonvolatile memory; an error position management unit for registering all physical blocks constituting the same group with the physical block in which a writing error occurred; a data reading unit for reading the error correction code from the physical block of the one group of said nonvolatile memory; an error correction unit for correcting the data of the physical block in which the writing error occurred, the physical block being registered in said error position management unit, on the basis of data of the physical blocks in which an error does not occur of the group including the registered physical block; and a sequencer for controlling the semiconductor recording device to: register a piece of position information of a writing error that occurred before elapse of a first reference time T1 from occurrence of the previous writing error; read blocks registered in said error position management unit at a predetermined timing; correct data of the error physical block by using said error correction unit; and rewriting the data to a new physical block.

In the above-mentioned configuration, according to the present invention, the error correction code (ECC) is constituted from a plurality of physical blocks constituting the nonvolatile memory and is recorded in the nonvolatile memory. In the case where the writing error occurred, a time interval between the writing error that occurred immediately before and the present writing error is detected. Then, when said time interval is a reference value or less, the error position management unit registers the writing error occurrence block number and the block numbers grouped with the writing error occurrence block in the error correction code. And then, the writing error registered in said error position management unit is loaded, and the error of the writing error block registered in said error position management unit is corrected on the basis of the error correction code and then the corrected data is rewritten. Thus, even when the writing errors have occurred in relatively short intervals, the rewriting process can be delayed.

In this manner, data can be continuously accepted from the host apparatus and the overflow of the buffer memory of the host apparatus can be prevented. Accordingly, in the multi-level flash memory requiring long time for the rewriting process, frequent occurrence of the writing errors is accepted. Even in a case where the host apparatus records an image signal in an imaging apparatus, a real-time recording of the image signal can be realized.

### BRIEF DESCRIPTION OF THE DRAWING

FIG. 1 is a schematic view showing an accumulation state of electrons in a multi-value flash memory;

FIG. 2 is a view showing a cell share in a physical block of the multi-value flash memory;

FIG. 3 is a state shifting view showing a cell in the multi-value flash memory;

FIG. 4 is a configuration view of a semiconductor recording device according to an embodiment;

FIG. 5 is an explanation view of arrangement of data and parity in physical blocks according to the present embodiment;

FIG. 6 is an explanation view of creation of the parity in the present embodiment;

FIG. 7 is a process flowchart of a case where a writing error has occurred in the present embodiment;

FIG. 8A is a conceptual view showing a physical block where the writing error has occurred in the present embodiment;

FIG. 8B is a conceptual view showing a page to be restored of the physical block where the writing error has occurred in the present embodiment;

FIG. 8C is a conceptual view showing the physical block where the writing error has been restored in the present embodiment;

FIG. 9 is an explanation view showing a registration example of an error position showing the restoration process of the writing error;

FIG. 10A is a time chart showing the restoration process of the writing error in the present embodiment; and

FIG. 10B is a time chart showing the restoration process of the writing error in the present embodiment.

### DESCRIPTION OF THE PREFERRED EMBODIMENTS

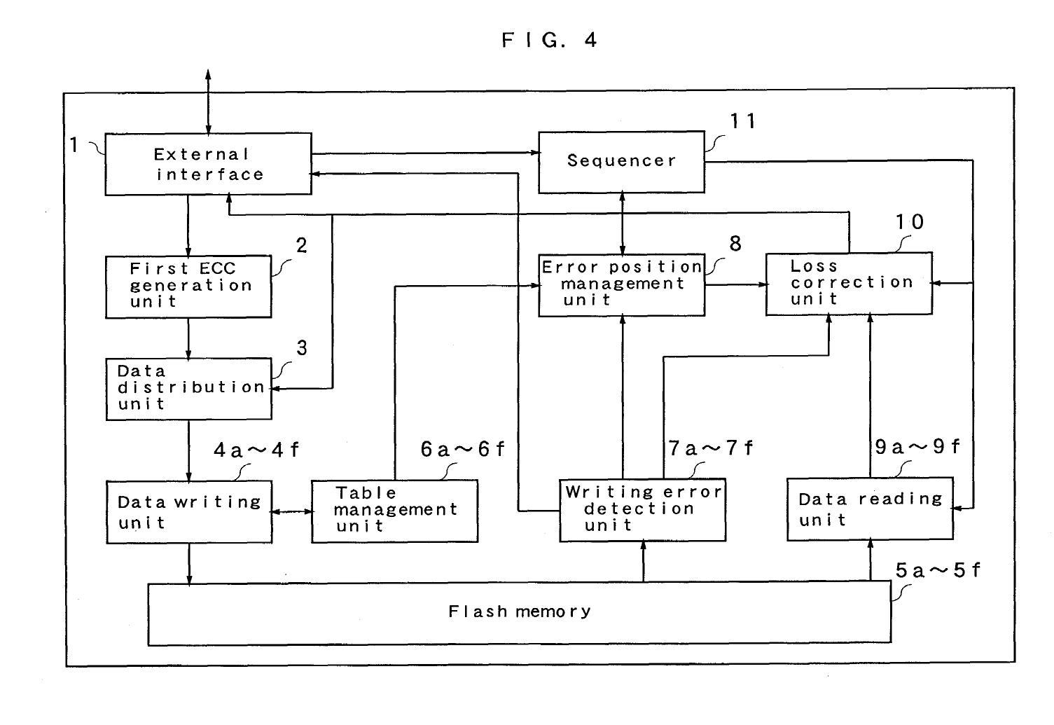

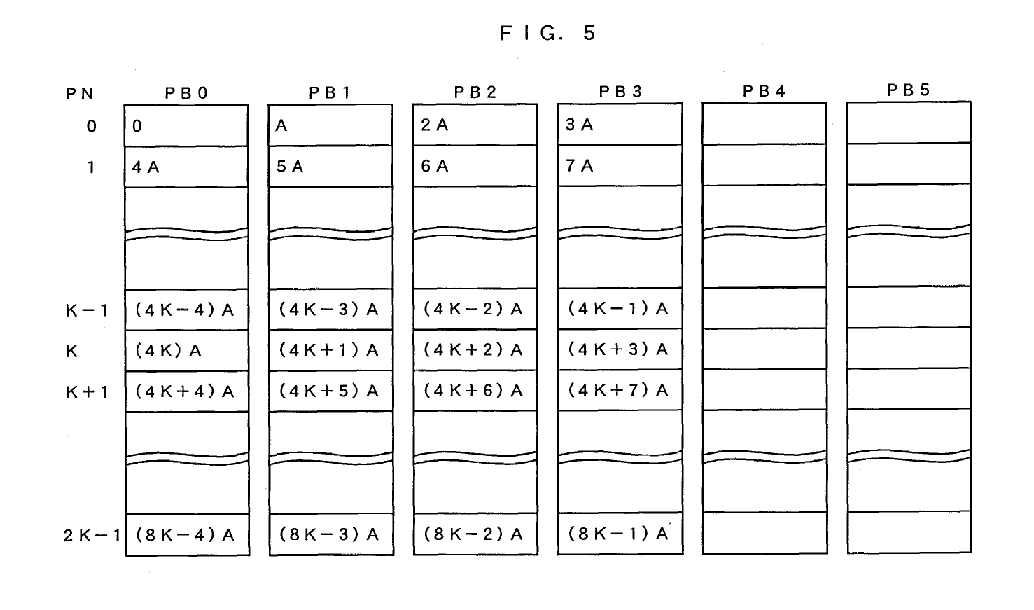

FIG. 4 shows a configuration view of a semiconductor recording device according to a first embodiment of the present invention. In the embodiment, an external interface 1 is for receiving a command and data from a host apparatus that is not shown in the drawing and transferring the data.

An ECC generation unit 2 adds an error correction parity to the received writing data when receiving a write command from the host apparatus. To be more detailed, the ECC generation unit 2 adds an ECC parity of M words (M is a natural number) to N words extracted at intervals of A words with respect to data of inputted (A×N) words (A and N are natural numbers) and generates the A number of first error correction codes of (N+M) words. Meanwhile, the ECC parity is a code having a function of error correction. Here, the embodiment will be explained assuming that N is 4, M is 2, and A is 512.

A data distribution unit 3 distributes the error correction codes to which the ECC parity is added by the ECC generation unit 2 to the respective physical blocks of a flash memory in units of words. To be more specified, the data distribution unit 3 distributes A words to each of the (N+M) number of physical blocks by repeating distribution of (N+M) words of the error correction code generated by the ECC generation unit 2, six words here, to different physical blocks of the flash memory for every one word.

Data writing units 4a to 4f record data of A words per physical block distributed by the data distribution unit 3 into the respective physical blocks of the nonvolatile memory. Since (N+M) is six here, the data writing units 4a to 4f are mounted in parallel all and write data to each one block of the six number of flash memories 5a to 5f.

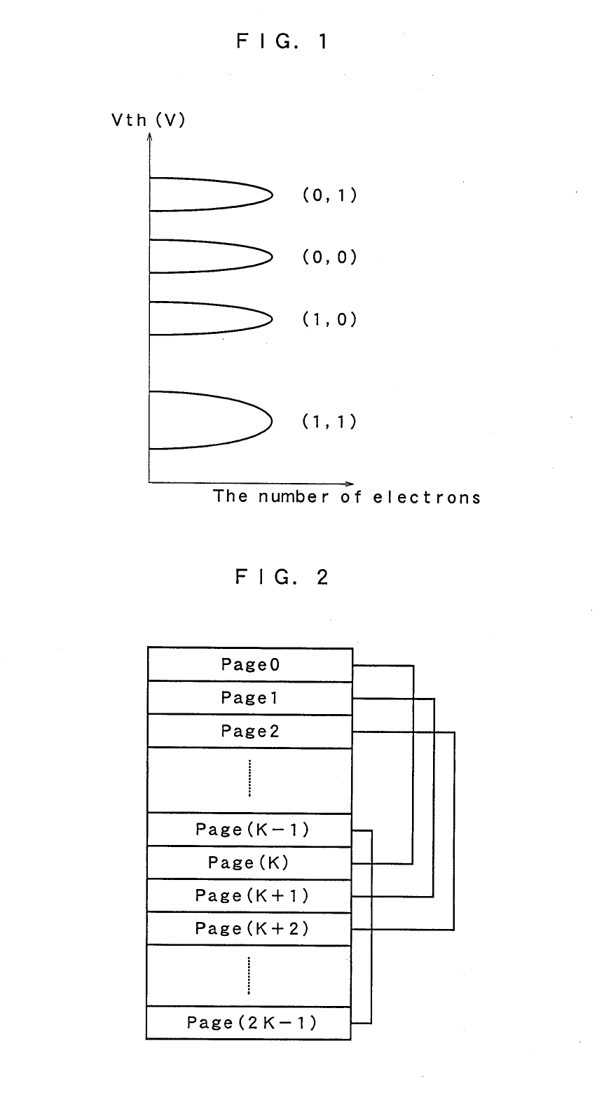

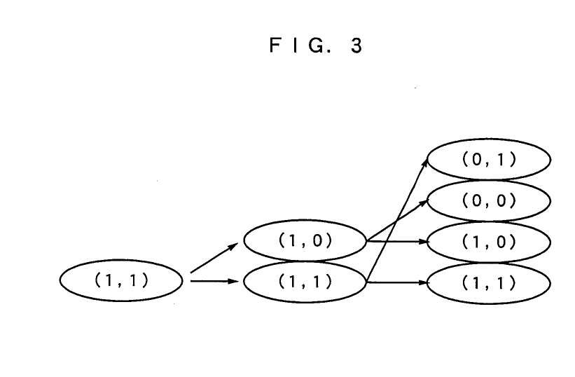

The semiconductor recording device according to the embodiment has the (N+M) number of the flash memories, six flash memories 5a to 5f here. The flash memories 5a to 5f are 4-level flash memories, each of which is composed of many physical blocks. The physical block is an erasing unit and has the 2K number of pages (K is a natural number). As shown in FIG. 2 mentioned above, the flash memory is managed with page numbers from 0 to 2K−1. Among them, the K number of pages of page numbers 0 to K−1 are composed of the first pages of memory cells, and the K number of pages of page numbers K to 2K−1 are composed of the second pages of the memory cells. Each of the pages has a storage capacity of A words. Here, 1 word is, for example, 1 byte, namely, 8 bits. Four logical blocks that constitute the error correction code generated by the ECC generation unit 2 is called a logical segment, and the (N+M) number of physical blocks related to the respective logical segments are called a group.

Table management units 6a to 6f manage a logical-physical conversion table and a block entry table, and the number of the table management units to be mounted is six, equal to that of the flash memories. The logical-physical conversion table relates the logical block specified via the external interface 1 to an address of the physical block corresponding to the logical block. The block entry table is generated after applying a power source, and is a table showing whether each of the physical blocks is used or not. Each of the table management units 6a to 6f operates independently, and manages the tables and extracts a new physical block corresponding to the logical block in the writing of data.

Writing error detection units 7a to if detect a writing error occurring when data are written in the flash memories 5a to 5f, respectively, and the number of the writing error detection units to be mounted is six, equal to that of the flash memories.

In response to the error detected by the writing error detection units 7a to 7f, an error position management unit 8 registers: a physical block in which a writing error occurred; and block numbers of the physical block and other physical blocks (hereinafter referred to as element blocks) constituting a group. In a case where a rewriting process is carried out immediately after the occurrence of the writing error, the error position management unit 8 does not need to operate. On the other hand, in a case where the rewriting process is not carried out immediately after the occurrence of the writing error, the error position management unit 8 registers the physical block in which the writing error occurred and the element blocks as physical blocks to which the rewriting is carried out in future.

Data reading units 9a to 9f read data from each of the flash memories 5a to 5f corresponding to a specified address when a reading command is given from the host apparatus to the semiconductor recording device. In addition, the data reading units 9a to 9f also read data in a case where an error has occurred in writing the data and the writing error managed by the error position management unit 8 is corrected on the basis of the error correction code.

When an error occurs in the writing of data, an error correction unit 10 corrects the error and restores the data on the basis of data read via the data reading units 9a to 9f and an error position indicated by the error position management unit 8. The restored data is written back to any one of the flash memories 5a to 5f via the data distribution unit 3 and the data writing units 4a to 4f.

When a writing command issued from the host apparatus is given and a writing error occurs in writing data, a sequencer 11 monitors intervals of the error and change a scenario described later. To be more detailed, the sequencer 11 controls the data reading units 9a to 9f to read data of the error block and the element blocks of the error block based on intervals of errors of the write command, and controls the error correction unit 10 to carry out an error correction. Moreover, the sequencer 11 writes the restored data of the error block into a new physical block via the data distribution unit 3 and the data writing units 4a to 4f.

An operation of the semiconductor recording device according to the embodiment will be explained. At first, the table management units 6a to 6f read the logical-physical conversion table at the application of power source, and create the block entry table showing use states (used or unused) of all physical blocks. In the embodiment, the table management units 6a to 6f create 6 block entry tables to control 6 flash memories.

Next, the data writing will be explained. In the case of writing data, the host apparatus transfers a logical address and writing data with a writing command to the semiconductor recording device. Here, the writing data is shown in units of the words, data from word 0 to word 8KA are transferred as the writing data. When receiving the writing command via the external interface 1, the ECC generation unit 2 divides the writing data in units of the words and in every A words and adds the ECC parity to the divided data. The data distribution unit 3 distributes data to be recorded to each flash memory in every A words and inputs the data into the data writing units 4a to 4f, respectively.

FIG. 5 is a view showing a relationship of parallel physical blocks to the data and parity in a case of carrying out the striping recording to the six flash memories 5a to 5f. In the drawing, physical block PB0 is a physical block of the flash memory 5a, physical block PB1 is a physical block of the flash memory 5b, and in a similar fashion, physical blocks PB2, PB3, PB4, and PB5 are physical blocks of the flash memories 5c, 5d, 5e, and 5f, respectively. The PN shows a page number. A word number in a page of the flash memory, a flash memory number, a physical block number of each flash memory, and a page number in the physical block are uniquely determined with respect to a writing address specified by the external host apparatus. The respective pages of physical blocks PB0 to PB3 in FIG. 5 show first numbers of the words written into the pages. Then, the ECC parity generated by the ECC generation unit 2 is written into the respective pages of physical blocks of the flash memories 5e and 5f.

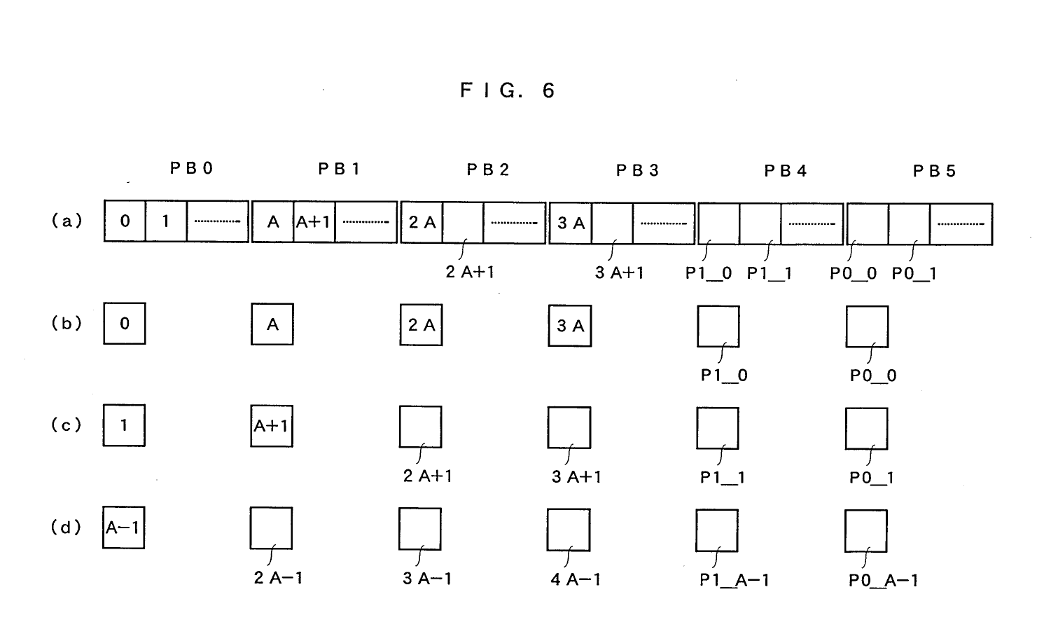

FIG. 6 shows a method for generating the ECC parity in the ECC generation unit 2. FIG. 6 shows a method for generating the ECC parity in the ECC generation unit 2. FIG. 6(a) shows assignments of the words in pages 0 of the respective physical blocks PB0, PB1, PB2, PB3, PB4, and PB5. FIG. 6(b) is a view of relation with the ECC parity regarding the first words of the respective pages, FIG. 6(c) is a view of relation with the ECC parity regarding the second words of the respective pages, and FIG. 6(d) is a view of relation with the ECC parity regarding the final words of the respective pages. As described above, assuming plural pieces of data as components, the ECC generation unit 2 extracts a plurality of the components from different physical blocks, PB0 to PB3 here, respectively and generates the ECC parity, and records the ECC parities of 2 bytes into other physical blocks, PB4 and PB5 here, by 1 byte.

Here, the error correction code will be explained. The ECC generation unit 2 divides 1 word, namely, 1 byte is into higher 4 bits and lower 4 bits, and handles each of the 4 bits as 1 symbol. Then, a Reed-Solomon code of (6, 4) is configured in the Galois field of GF(16) employing an expression, X4+X+1,as a generating polynomial, and a parity of two symbols. That is, when an input symbol is (a3, a2, a1, and a0) and a parity symbol is (p1 and p0), an information polynomial of the input symbol is shown by the following expression:

A(X)=a3×X³+a2×X²+a1×X¹+a0 (1).

In addition, a code generation polynomial is shown by the following expression:

G(X)=(X−α⁰)(X−α) (2).

In this code generation polynomial, a remainder R(X) of A(X)'X²/G(X) is obtained, and a primary term of the R(X) is shown by p1 and a 0th-order term of R(X) is shown by p0. FIG. 6 shows that the primary terms, P1_0, P1_1, to P1_(A-1), are written into the physical block PB4, and the 0th-order terms, P0_0, P0_1, to P0_(A-1), are written into the physical block PB5.

In this manner, even when errors occur in the writing up to two physical blocks and two elements of a2, a1, a0, p1, and p0 generate errors, the data can be restored by carrying out the error correction described below based on other elements of the error correction code.

The data writing units 4a to 4f write data distributed by the data distribution unit 3 into the respective pages of physical blocks of the flash memories, and write the distributed ECC parities into the flash memories 5e and 5f. In the writing to the flash memory, it is determined that a cell error occurs in the flash memory in the case where the Vth does not reach a desired electric potential within a predetermined time. The writing error detection units 7a to 7f determine an output of the error obtained from the flash memory as an error position. In the case where the writing error has occurred, the physical block in which the writing error occurred is not used after this, and data is written into another physical block subsequently. Accordingly, a process for registering the physical block in which the error occurred as a bad block and writing data again after extracting a new physical block.

Next, a process after the occurrence of the writing error will be explained. In the embodiment, the error correction can be carried out even when the writing errors have occurred in two physical blocks of the six physical blocks constituting the group. Accordingly, the operation proceeds based on the number of physical blocks in which the writing error occurred of one group in accordance with the following scenarios

(Scenario 1) In a case where the number of physical blocks in which the writing error occurred in one group is three or more, the nonvolatile recording device returns an error status to the host apparatus, and the host apparatus carries out the rewriting on only data related to the writing command.

(Scenario 2) In a case where the number of error blocks is two or less, a first reference time T1 elapsed after the previous writing error, and then a writing error occurred, after carrying out the ECC correction on the error page and previous pages of the same physical block that is already written on the basis of the command, and then the data of the pages are written into a new physical block again.

(Scenario 3) In a case where the number of error blocks is two or less, and a writing error occurred until a first reference time T1 elapses after the previous writing error, the error position management unit 8 registers the element blocks related to the written physical error block. In this case, the semiconductor recording device does not return an error status and registers the blocks by classifying the case into a case where the number of physical blocks of the writing error is one or a case where the number is two.

(Scenario 4) In a case where the previous writing error occurred, the first reference time T1 elapsed after the registration, and then no writing error occurred, errors of the error page and previous pages of the same physical block that is already written before the error page of the writing block registered in the error position management unit 8 are corrected by the ECC, and the pages are written again. On this occasion, the group of the physical blocks in which two writing error occurred is preferentially corrected.

(Scenario 5) In a case where the number of the error blocks is two or less, and a writing error occurred by the time when a second reference time T2 has elapsed after the rewriting, the error position management unit 8 registers the element blocks related to the writing physical error block. In this case, the semiconductor recording device does not return the error state and registers the blocks by classifying the case into a case where the number of the writing error physical blocks is one or a case where the number is two.

(Scenario 6) In a case where the second reference time T2 has elapsed after the restoration of the previous error and the rewriting and no writing error occurred, data is rewritten into a new physical block after errors of the error page and previous pages of the same physical block that is already written before the error page of the writing block registered in the error position management unit 8 are corrected by the ECC. Also in this case, the error correction of the group in which two writing error occurred is preferentially carried out.

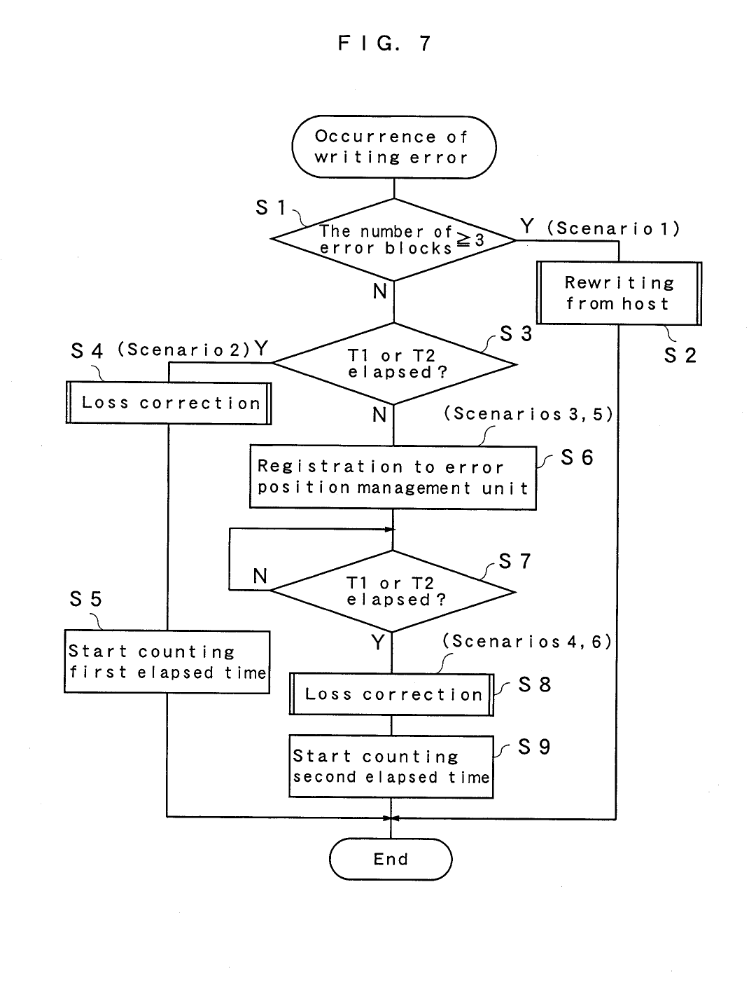

Referring to a flowchart of FIG. 7, the above-mentioned Scenario 1 to Scenario 6 will be explained in detail.

(Scenario 1) At first, it is determined whether or not the number of the physical blocks in which the number of writing errors occurred at S1 is three or more, and in the case of three or more, proceeding to step S2, the rewriting is carried out by the host apparatus. Since the probability that writing errors occur in three or more physical blocks in one group is nearly zero, it can be considered that the error occurred because of a defect of the nonvolatile memory. Accordingly, in this case, in the same manner as that of an abnormal process occurring in the malfunction, the semiconductor recording medium returns an error status to the host apparatus immediately after the occurrence of the writing error. At this time, the host apparatus rewrites data related to the command. Scenario 1 describes a case where the error correction based on the written error correction code is impossible, and the error propagating to the cell-sharing part also cannot be corrected. However, when the error occurrence probability is 1E-06, probability that errors occur in three of the six physical blocks is approximately 2E-17, which is quite small occurrence probability and accordingly is not a matter.

(Scenario 2) In the case where errors occurred in 2 or less physical blocks, it is judged whether or not the first reference time T1 has elapsed after the previous writing error occurred at S3. When an elapsed time from the occurrence of the previous writing error is T_Real, the flow proceeds to S4 in a case where the following expression (3) is satisfied and the error correction unit 10 corrects the error,

T_Real>T1 (3).

Here, the reference time T1 will be explained. At first, it is assumed that:

Rin is an input rate of an image signal;

Tout is a writing-guarantee time per one group of the semiconductor recording device; and

Terr is time from the occurrence of the writing error to the returning of the error status to the host.

In the case where the writing error occurred once, time equivalent to (Tout+Terr) is redundantly produced compared to a case where the writing is successful, and a speed derived from time required for the data writing including the redundant time can be considered as a writing speed. On this occasion, data of Rin×(Tout+Terr) is accumulated in the buffer memory of the host apparatus. Accordingly, a condition to allow the host apparatus to rewrite data when the writing error occurred is that a free size of the buffer memory of the host apparatus is Rin×(Tout+Terr) or more.

Meanwhile, when a data amount of the logical segment is D, a data amount accumulated in the buffer memory of the host apparatus reduces at Tout×(D/Tout−Rin) in an average manner. Thus, when time required to release the data of Rin×(Tout+Terr) from the buffer memory of the host apparatus is defined by T_REF, the time is shown by the following expression:

T_REF=(Rin×(Tout+Terr))/(D−Tout×Rin) (4).

Accordingly, the time T_REF is the first reference time T1. The second reference time T2 described below is defined in the same manner.

As described above, the sequencer 11 manages states of a command to be inputted and the occurrence of the writing error, estimates a timing when all data stored in the buffer memory of the host apparatus are released because of the previous writing error, and carries out the error restoration of the writing error that occurred. After that, counting of a first elapsed time starts at S5.

The error correction and the rewriting process of scenario 2 will be explained in detail. In the embodiment, since the four-level flash memory is employed, two pages, the first page and the second page, share each memory cell. Consequently, when an error occurs in the writing to the second page, the error may propagate to the first page sharing the memory cell as described above. Accordingly, the writing error detection units 7a to 7f detect whether or not the writing error occurred in the writing. Since the states of cell-sharing in a physical block is varies depending on a semiconductor process and a manufacturing company of the semiconductor, the rewriting is carried out under a condition where information of the cell-sharing of the flash memory is not disclosed. For example, it is assumed that an error occurred in the writing to the (K+1)th page. If the error occurrence page is the second page, the first page sharing a cell with the page (K+1) is included in any one of the previous pages, the page 0 to the page K.

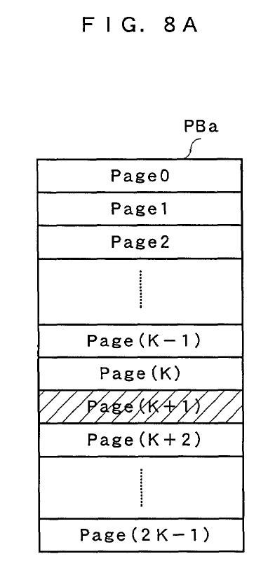

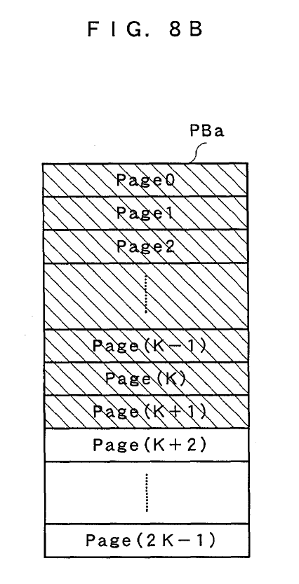

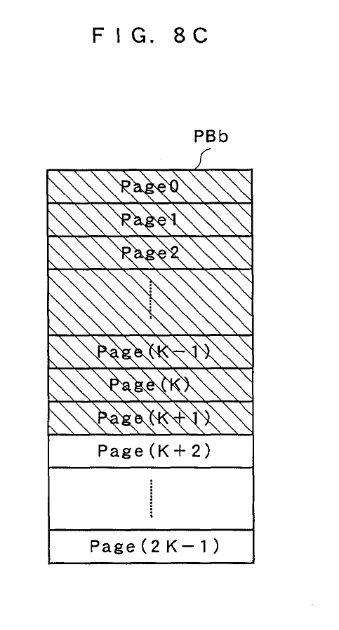

FIG. 8A to FIG. 8C are explanation views of a case of restoring the error occurrence block. In this case, the process is carried out in line with the following steps.

(S11) The writing error detection unit detects a physical block and a page in which the writing error occurred. FIG. 8A is a schematic diagram showing the pages of a case where an error occurred in the writing to the physical block PBa, and shows that the writing error occurred in writing data into the page (K+1) shown by hatching of the physical block PBa.

(S12) The table management units 6a to 6f secure a new physical block.

(S13) The data reading units 8a to 8f read data of pages (page 0 to page (K+1)) of other physical blocks of the group assuming the previous page in which an error occurred as a component of the error correction code. FIG. 8B is a schematic view showing pages that are targets of the error correction in the physical block PBa in which the error occurred by hatching.

(S14) The error correction unit 10 corrects the error by using data of the pages read by the data reading units 8a to 8f and the position information of the error occurrence physical block.

(S15) Corrected data of the pages are written into pages of a new physical block. FIG. 8C shows a state of a new physical block PBb after the restoration of data.

Here, the error correction by the error correction unit 10 will be explained. Here, 6 symbols received by the error correction unit 10 are b3, b2, b1, b0, q1, and q0. In these symbols, b3 is data read from the physical block PB0, b2 is data read from the physical block PB1, b1 is data read from the physical block PB2, b0 is data read from the physical block PB3, q1 is data read from the physical block PB4, and q0 is data read from the physical block PB5, respectively. Among them, the symbol read from the block in which an error was detected may include an error. In this case, the following expression is a received-code polynomial,

U(X)=b3×X⁵+b2×X⁴+b1×X³+b0×X²+q1×X+q0 (5).

Then, in the U(X), U(1) and U(a) are calculated assuming two symbols that may have errors as 0. Here, when the error symbol positions are y0 and y1 (an integral number satisfying 0≦y0 and y2≦5) and scales of the errors are z0 and z1, the following expression (6) and (7) are satisfied,

z0+z1=U(α°) (6), and

α^{y0}×z0+α^{y1}×z1=U(α) (7).

Since the error positions y0 and y1 are already-known in the expressions (6) and (7), the error scales z0 and z1 can be calculated and the symbols related to the error positions y0 and y1 can be corrected to z0 and z1, respectively, by solving the simultaneous equation with two unknowns. In this manner, even when the error correction up to two pages is impossible in the error correction codes read from one group, data of the pages related to the error position can be corrected by calculating on the basis of data of the remaining four pages and two error positions.

As explained above, in the case where a writing error occurred in the (K+1)th page, there may be a page sharing a cell in any one of the pages before the (K+1)th page and may be a possibility that the error propagates to the data of the page. Accordingly, the error correction is carried out after reading data of the corresponding pages of other physical blocks, the data constituting the error correction code, and the data is rewritten after restoring the data. The semiconductor recording device repeats the process to all pages already-written before the page in which the error occurred of each block, namely, 0th page to Kth page. In this manner, the error propagation based on the cell-sharing can be avoided. In addition, since the scenario 2 is carried out limiting to the case of satisfying the expression (3), namely, a case where an interval of occurrence of the writing error is relatively longer, the buffer memory of the host apparatus never overflows.

Meanwhile, in the above-mentioned explanation, an error occurring related to the write command is also corrected and rewritten without returning the error status to the host apparatus, but the error status may be returned to the host apparatus and the host apparatus may rewrite the data related to the command.

Next, referring to FIG. 7, a case where the occurrence time of the subsequent writing error does not satisfy the expression (3) will be explained.

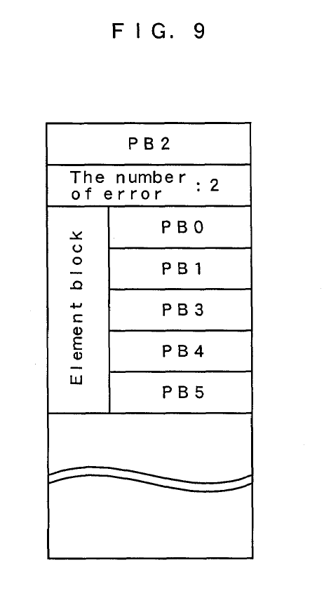

(Scenario 3) In a case where the number of the writing error physical blocks in one group is two or less in scenario 3, the error position management unit 8 registers the error physical block and the element blocks in each error at S6. On this occasion, in order to carry out the data restoration process preferentially to the group having the larger number of physical blocks with writing errors, the semiconductor recording device registers the blocks by classifying the case into a case where the number of the writing error physical blocks is one or a case where the number is 2 as shown in FIG. 9.

(Scenario 4) Scenario 4 is for restoring the writing error registered by the error position management unit 8 in accordance with the error correction code and carrying out the rewriting. In this case, as shown at S7 and S8, the error correction and the rewriting are carried out after the first reference time T1 elapsed from the occurrence of the previous writing error. Moreover, after that, the counting of the second elapsed time starts at S9. In this case, similar to scenario 2, since at least Rin×(Tout+Terr) of the free size of the buffer memory of the host apparatus is guaranteed, the buffer memory of the host apparatus never overflow in scenario 4. In addition, it is preferable to carry out scenario 4 immediately after a success of a writing operation related to the writing command issued by the host apparatus. This is because that the host apparatus recognizes data is currently written and detects a writing time, just like the writing time of data ordered from the host apparatus is extended. Since the writing times of the semiconductor memories vary in three times or more, the increase of the writing time is an expected event to the host apparatus.

In addition, when the writing time of data ordered from the host apparatus is counted and the rewriting process is carried out only in a case where the writing ended within a third reference time T3, the process can be hidden. Moreover, data is accumulated in the buffer memory of the host apparatus when scenario 4 is carried out, and accordingly the counting of the first elapsed time that started at S5 is reset.

The case where the number of error blocks is two or less and a writing error occurred before the elapse of the second reference time T2 from the rewriting will be explained.

(Scenario 5) In scenario 5, when the number of the writing error physical blocks in one group is two or less, the error position management unit 8 registers the error physical block and the element blocks in each error at S6. On this occasion, in order to carry out the data restoration process preferentially to the group having the larger number of physical blocks with writing errors, the semiconductor recording device registers the blocks by classifying the case into a case where the number of the writing error physical blocks is one or a case where the number is two as shown in FIG. 9.

(Scenario 6) Scenario 6 is for restoring the writing error registered by the error position management unit 8 in accordance with the error correction code and carrying out the rewriting. In this case, as shown at S7 and S8, the error correction and the rewriting are carried out after the second reference time T2 elapsed from the occurrence of the previous writing error. Moreover, after that, the counting of the second elapsed time starts at S9. In this case, similar to scenario 2, since at least Rin×(Tout+Terr) of the free size of the buffer memory of the host apparatus is guaranteed, the buffer memory of the host apparatus never overflow in scenario 6.

The error correction and the rewriting carried out in scenarios 4 and 6 are carried out in the following steps.

(S21) Preferentially from a group in which the number of the writing error physical blocks is two, the error position management unit 8 reads the respective physical block numbers of the group and a position of the physical block in which the writing error occurred.

(S22) A new physical block is secured.

(S23) The data reading units 8a to 8f read the pages of a physical block in which the writing error does not occur in the group read at S21.

(S24) The error correction unit 10 carries out the error correction by using data of the pages read by the data reading units 8a to 8f and the position information of the error occurrence physical block.

(S25) Data of the page whose error was corrected is written into a new physical block.

(S26) A writing end status is returned to the host apparatus.

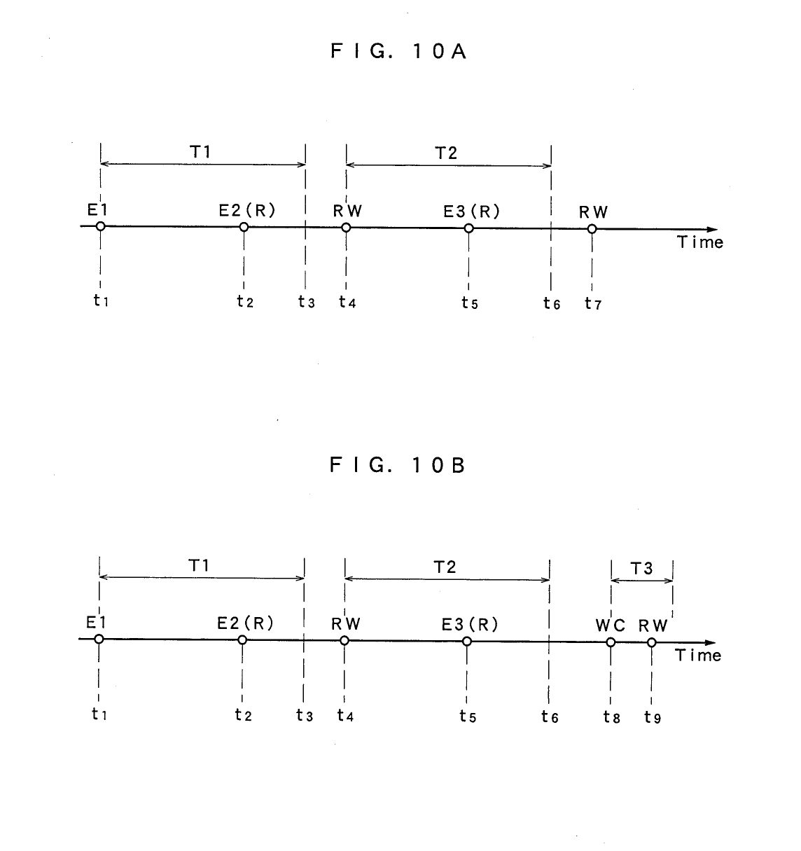

Next, referring to a time chart, the error correction and the rewriting process after the occurrence of this error will be explained. The horizontal axes in FIG. 10A and FIG. 10B represent a time axis, and the number of errors in the physical blocks of one group is two or less. In FIG. 10A, a first error E1 occurred at a timing of time t1. At this time, the sequencer 11 carries out the error correction in accordance with scenario 2 if there is no error before. Next, a second error E2 occurred at time t2. In this case, since the second error E2 occurred within the reference time T1, the error position management unit 8 registers the case in accordance with scenario 3 without carrying out the error correction at the time t2. Then, since the reference time T1 elapses at time t3, the error correction and the rewriting (RW) are carried out in accordance with scenario 4 at the timing of subsequent time t4. Here, it is required to delay the transferring of data from the host apparatus because of the rewriting, and accordingly data is accumulated in the buffer of the host apparatus. Consequently, in a case where an error further occurred, it is required to judge based on time from the rewriting time whether the error is immediately corrected or corrected after registration. Thus, the counting of time starts from time t4 in the rewriting.

After that, if a third error E3 occurs at time t5 within a range of the reference time T2, the error position management unit 8 registers (R) the case in accordance with scenario 5. Then, since the second reference time T2 elapses at time t6, the error correction and the rewriting (RW) are carried out in accordance with scenario 6 at the timing of subsequent time t7. Here, both of the first and second reference times T1 and T2 can be T_REF. In this manner, data to be transferred to the buffer in the host apparatus can be continuously transferred without overflowing.

The process from time t1 to t6 shown in FIG. 10B is the same as that in FIG. 10A. In FIG. 10B, instead of the rewriting at time t7, the rewriting is carried out immediately after data is written in accordance with a subsequently-sent writing command (WC). When time for the data writing according to the writing command is long, there is a possibility that the buffer of the host apparatus fails to accumulate data. Accordingly, the time for the writing is within the third reference time T3 after the time for the writing according to the writing command is compared to the third reference time T3. The third reference time T3 is sufficiently shorter than time accepted as the writing time for data. Then, the data restoration and the rewriting may be carried out.

As described above, according to the embodiment, in the case where the error correction code is configured in the writing of data and is recorded into the nonvolatile memory, and a writing error occurred, a time interval between the writing error that occurred immediately before and the present writing error is detected. Then, when said time interval is a reference value or more, the rewriting is carried out immediately after the occurrence of the writing error, and when said time interval is less than the reference value, the error position management unit registers the writing error occurrence block number and the block numbers grouped with the writing error occurrence block in the error correction code. And then, when the interval with the writing error that occurred immediately before is equal to the reference time or more, the block of the writing error registered in the error management unit is loaded. And, data is restored by correcting the error of the block based on the error correction code and then is rewritten. Thus, even when the writing errors have occurred in relatively-short intervals, the rewriting process can be delayed and accordingly the overflow of the buffer memory of the host apparatus can be prevented. Consequently, also in a case where the writing errors frequently occurred in the multi-level flash memory that requires long time for the rewriting process, data can be continuously written. Even in a case where the host apparatus is a real-time recording apparatus for image signal, the real-time recording can be realized.

Meanwhile, in the embodiment, the rewriting is carried out preferentially restoring the group in which two writing errors occurred; however, an occurrence time may be given preference and a group with one writing error does not have to be corrected in some cases.

In the above-mentioned explanation, the start of scenario 2 is at the occurrence of the writing error in the case where time from the occurrence of the previous writing error is equal to the reference time T1 or more. However, the reference time T1 may be defined on the number of the writing commands in a case where the write command is periodically given. Additionally, in the process of scenario 3, the reference time T1 may be defined on the number of the writing commands in which the writing error did not continuously occur.

Moreover, the error position management unit may or may not record the error position information in the process of scenario 3 in the nonvolatile memory in accordance with a frequency of the occurrence of the writing error.

In addition, the start of scenario 3 may be in a case where the command is not issued from the host apparatus for a predetermined time. Furthermore, the scenario 3 may be carried out as a process immediately after the application of power source or at the power-off.

Meanwhile, in the above-mentioned explanation, the error correction code is two parities in order to simplify the description, but obviously the parity may be added more than two or may be one. Specifically, the number M of the parities may be an arbitrary natural number, one or more.

The embodiment explained the semiconductor recording device employing four-level flash memory in which the number of bits to be stored in one memory cell is 2 bits. However, the present invention can be applied to a multi-level flash memory able to store 3 bits or more in one memory cell. Additionally, even when applied not only to the multi-level flash memory but also to a two-level flash memory and other nonvolatile memory, the present invention can obtain the same effect.

Moreover, in the embodiment, the respective components of the error correction code are recorded in the respective flash memories by using six flash memories; however, the components may be recorded in different physical blocks of one flash memory.

In addition, in the embodiment, though the data distribution unit 3 distributes data evenly to the physical blocks constituting one group, the distribution does not have to be even.

Furthermore, in the embodiment, the error position management unit registers the physical block in which a writing error occurred and the element blocks constituting a group with the physical block as shown in FIG. 9. However, the error correction can be carried out also when all physical blocks constituting the same group with the physical block in which the writing error occurred.

Regarding the semiconductor recording device such as the memory card, since being able to correct a writing error that occurred especially in an internal nonvolatile memory after the occurrence of the error and to maintain a writing speed in continuously writing data to a flash memory, the semiconductor recording device of the present invention has a great possibility to be used in a field of professional use requiring reliability.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese application No. 2008-242593 filed on Sep. 22, 2008 is hereby incorporated by reference.

What is claimed is:

1. A semiconductor recording device that incorporates a nonvolatile memory composed of a plurality of physical blocks, the physical block being composed of a plurality of pages, and configures the predetermined number of said physical blocks as one group, comprising:
an ECC generation unit for adding an ECC parity to data inputted in data writing and generating an error correction code;
a data distribution unit for distributing component units of the error correction code generated by said ECC generation unit to each physical block of one group;
a data writing unit for writing the data distributed by said data distribution unit into each physical block of the one group of the nonvolatile memory;
a writing error detection unit for detecting a writing error in the data writing to the nonvolatile memory;
an error position management unit for registering all physical blocks constituting the same group with the physical block in which a writing error occurred;
a data reading unit for reading the error correction code from the physical block of the one group of said nonvolatile memory;
an error correction unit for correcting the data of the physical block in which the writing error occurred, the physical block being registered in said error position management unit, on the basis of data of the physical blocks in which an error does not occur of the group including the registered physical block; and
a sequencer for controlling the semiconductor recording device to: register a piece of position information of a writing error that occurred before elapse of a first reference time T1 from occurrence of the previous writing error; read blocks registered in said error position management unit at a predetermined timing; correct data of the error physical block by using said error correction unit; and rewriting the data to a new physical block.

2. The semiconductor recording device according to claim 1, wherein
said sequencer corrects data of the error physical block by using said error correction unit with respect to a writing error that occurred after elapse of a first reference time T1 from the occurrence of the previous writing error and rewrites the data to a new physical block.

3. The semiconductor recording device according to claim 1, wherein said first reference time Ti is shown by:
(Rin×(Tout+Terr))/(D−Tout×Rin),
where Rin is an input rate of an image signal, Tout is a writing-guarantee time per one group of the semiconductor recording device, Terr is time from the occurrence of the writing error to returning of the error status to the host apparatus, and D is an amount of data recorded in the physical blocks of the one group without including the ECC parity.

4. The semiconductor recording device according to claim 1, wherein
said predetermined timing of said sequencer is a timing when a second reference time T2 has elapsed from the rewriting process related to the writing error.

5. The semiconductor recording device according to claim 4, wherein
said second reference time T2 is shown by:
(Rin×(Tout+Terr))/(D−Tout×Rin),
where Rin is an input rate of an image signal, Tout is a writing-guarantee time per one group of the semiconductor recording device, Terr is time from the occurrence of the writing error to returning of the error status to the host apparatus, and D is an amount of data recorded in the physical blocks of the one group without including the ECC parity.

6. The semiconductor recording device according to claim 1, wherein
when a writing command is given from the host apparatus after a second reference time T2 has elapsed from the rewriting process of the writing error, said predetermined timing of said sequencer is a timing after completion of data writing based on the writing command.

7. The semiconductor recording device according to claim 6, wherein
said second reference time T2 is shown by:
(Rin×(Tout+Terr))/(D−Tout×Rin),
where Rin is an input rate of an image signal, Tout is a writing-guarantee time per one group of the semiconductor recording device, Terr is time from the occurrence of the writing error to returning of the error status to the host apparatus, and D is an amount of data recorded in the physical blocks of the one group without including the ECC parity.

8. The semiconductor recording device according to claim 1, wherein
when a writing command is given from the host apparatus after a second reference time T2 has elapsed from the rewriting process of the writing error, said predetermined timing of said sequencer is a timing at when data writing based on the writing command has been completed within the third reference time.

9. The semiconductor recording device according to claim 1, wherein
said predetermined timing of said sequencer is at least one of timings of application and cut of an electric power source to the semiconductor recording device.

10. The semiconductor recording device according to claim 1, wherein
said nonvolatile memory configures the N+M number of physical blocks as one group (N and M are natural numbers), and
said ECC generation unit adds an ECC parity of M words to N words extracted in intervals of A words to data of (A×N) (A is a natural number) words inputted in the data writing, and generates the A number of the error correction codes of (N+M) words.

11. The semiconductor recording device according to claim 10, wherein
said data distribution unit distributes the error correction codes of (N+M) words generated by said ECC generation unit in units of A words to the physical block of the one group by repeating the distribution to different physical block in the group of the physical group of said nonvolatile memory in every 1 word.
